(19) United States
(12) Patent Application Publication
(10) Pub. No.: US 2026/0046551 A1
(43) Pub. Date: Feb. 12, 2026

(54) SOUND ASSEMBLY AND ELECTRONIC DEVICE

(71) Applicant: Lenovo (Beijing) Limited, Beijing (CN)

(72) Inventor: Yifan YANG, Beijing (CN)

(21) Appl. No.: 19/297,715

(22) Filed: Aug. 12, 2025

(30) Foreign Application Priority Data
Aug. 12, 2024 (CN) 202411104044.9

(51) Int. Cl. H04R 1/32; G06F 1/16; H04R 1/06; H04R 7/16

(52) U.S. Cl. CPC H04R 1/323; H04R 1/06; H04R 7/16; G06F 1/1605; H04R 2499/15

(57) ABSTRACT

A sound assembly includes a carrier, a first electrode structure, a second electrode structure, and a vibration diaphragm. The first electrode structure is arranged on one side of the carrier. The second electrode structure is arranged facing and insulated from the first electrode structure. The vibration diaphragm is arranged on one side of the second electrode structure that faces away from the first electrode structure. The first electrode structure and the second electrode structure are configured to cooperate with each other to provide a first force that acts on a first end of the vibration diaphragm and a second force that acts on a second end of the vibration diaphragm. Magnitudes and/or acting directions of the first force and the second force are different.

### CROSS-REFERENCES TO RELATED APPLICATION

This application claims priority to Chinese Patent Application No. 202411104044.9, filed on Aug. 12, 2024, the entire content of which is incorporated herein by reference.

### FIELD OF TECHNOLOGY

The present disclosure relates to a sound assembly and an electronic device.

### BACKGROUND

A display device needs to be connected to an external sound assembly to output sound, which increases costs. Thus, with the increasing number of audiovisual scenarios, a single directional sound assembly is no longer sufficient to satisfy audiovisual experience of users.

### SUMMARY

One aspect of this disclosure provides a sound assembly, including a carrier, a first electrode structure, a second electrode structure, and a vibration diaphragm. The first electrode structure is arranged on one side of the carrier. The second electrode structure is arranged facing and insulated from the first electrode structure. The vibration diaphragm is arranged on one side of the second electrode structure that faces away from the first electrode structure. The first electrode structure and the second electrode structure are configured to cooperate with each other to provide a first force that acts on a first end of the vibration diaphragm and a second force that acts on a second end of the vibration diaphragm. Magnitudes and/or acting directions of the first force and the second force are different.

Another aspect of this disclosure provides an electronic device, including a display assembly, a light-transmitting layer, a first electrode structure, a second electrode structure, and a vibration diaphragm. The display assembly is configured to output an image. The light-transmitting layer is configured to allow the image to be visible through the light-transmitting layer. The light-transmitting layer has a first side facing the display assembly and a second side facing away from the display assembly. The first electrode structure is arranged on the second side of the light-transmitting layer. The second electrode structure is arranged facing and insulated from the first electrode structure. The vibration diaphragm is arranged on one side of the second electrode structure that faces away from the first electrode structure. The first electrode structure and the second electrode structure are configured to cooperate with each other to provide a first force that acts on a first end of the vibration diaphragm and a second force that acts on a second end of the vibration diaphragm. Magnitudes and/or acting directions of the first force and the second force are different.

### BRIEF DESCRIPTION OF THE DRAWINGS

In combination with accompanying drawings and with reference to the following description of embodiments, the above and other features, advantages, and aspects of the embodiments of the present disclosure will become more apparent. Throughout the drawings, a same or similar reference number represents a same or similar element. It should be understood that the drawings are schematic and that an element is not necessarily drawn to scale.

FIG. 1 is a schematic diagram showing an application scenario of a sound assembly and an electronic device according to some embodiments of the present disclosure.

FIG. 2 is a schematic structural diagram of a sound assembly according to some embodiments of the present disclosure.

FIG. 3 is a schematic structural diagram of another sound assembly according to some embodiments of the present disclosure.

FIG. 4 is a schematic top view of another sound assembly according to some embodiments of the present disclosure.

FIG. 5 is a schematic diagram of a sound assembly according to some

embodiments of the present disclosure.

FIG. 6 is a schematic block diagram of an electronic device according to some embodiments of the present disclosure.

FIG. 7 is a schematic block diagram of another electronic device according to some embodiments of the present disclosure.

### DETAILED DESCRIPTION

Embodiments of the present disclosure are described with reference to the accompanying drawings. However, the description is merely exemplary but is not intended to limit the scope of the present disclosure. In the following detailed description, to facilitate explanation, many details are provided to provide a full understanding of embodiments of the present disclosure. However, obviously, one or more embodiments can also be implemented without these details.

The terms used here are merely for the purpose of describing specific embodiments and are not intended to limit the present disclosure. The terms “comprising” and “including” used here indicate the presence of the described features, steps, operations, and/or members, but do not preclude the presence or addition of one or more other features, steps, operations, or members.

All terms used here (e.g., technical and scientific terms) have the meanings commonly understood by those skilled in the art, unless otherwise defined. The terms used here should be interpreted as having meanings consistent with the context of this specification and should not be interpreted in an idealized or overly rigid manner.

The expressions such as “at least one of A, B, and C” and “at least one of A, B, or C” should generally be interpreted according to the meaning commonly understood by those skilled in the art (for example, “a system including at least one of A, B, and C” or “a system including at least one of A, B, or C” should include but is not limited to a system having A alone, B alone, C alone, A and B, A and C, B and C, and/or A, B, and C). Those skilled in the art should also understand that essentially any conjunctive terms and/or phrases that indicate two or more optional items, whether in the specification, claims, or drawings, should be understood as presenting the possibility of including one of these items, either of these items, or both items. For example, the phrase “A or B” should be understood to include the possibility of “A,” “B,” or “A and B.”

Some block diagrams and/or flowcharts are shown in the accompanying drawings. Some blocks or a combination of the blocks in the block diagrams and/or flowcharts can be implemented by computer program instructions. These computer program instructions can be provided to a processor of a general-purpose computer, a special-purpose computer, or other programmable data processing apparatus, so that these instructions, when executed by the processor, can create an apparatus for implementing the functions/operations illustrated in the block diagrams and/or flowcharts.

Therefore, the technology of the present disclosure can be implemented in the form of hardware and/or software (including firmware, microcode, etc.). In addition, the technology of the present disclosure can take the form of a computer program product stored on a computer-readable medium containing instructions, which can be used with or combined with an instruction execution system. In the context of the present disclosure, a computer-readable medium may be any medium capable of containing, storing, conveying, propagating, or transmitting instructions. For example, the computer-readable medium may include, but is not limited to, electrical, magnetic, optical, electromagnetic, infrared, or semiconductor systems, apparatuses, devices, or propagation media. Specific examples of computer-readable media include magnetic storage apparatuses such as magnetic tapes or hard disks (HDD), optical storage apparatuses such as optical disks (CD-ROM), memories such as random access memory (RAM) or flash memory, and/or wired/wireless communication links.

Embodiments of the present disclosure provide a sound assembly, including a carrier, a first electrode structure arranged on one side of the carrier along a first direction, a second electrode structure arranged on one side of the first electrode structure along the first direction and insulated from the first electrode structure and capable of cooperating with the first electrode structure to provide a first force and a second force satisfying a perpendicular condition with (meaning perpendicular to or approximately perpendicular to) the first direction, and a vibration diaphragm arranged on one side of the second electrode structure and capable of acting in response to the first force and the second force to output sound. The vibration diaphragm includes a first end and a second end along the first direction. The first force and the second force can act on the first end and the second end, respectively. The magnitudes and/or acting directions of the first force and the second force can be different.

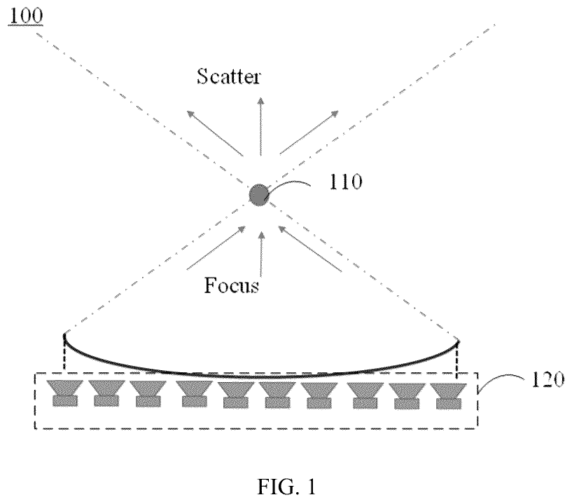

FIG. 1 is a schematic diagram showing an application scenario of a sound assembly and an electronic device according to some embodiments of the present disclosure. FIG. 1 only shows an example of a scenario of embodiments of the present disclosure to help those skilled in the art understand the technical content of the present disclosure, but it does not mean that embodiments of the present disclosure cannot be implemented in other devices, systems, environments, or scenarios.

As shown in FIG. 1, in an application scenario 100, a sound assembly 120 of embodiments of the present disclosure can cause sound emitted by the sound assembly to converge at a sound focus point 110.

The sound assembly 120 in FIG. 1 is only schematic.

The sound assembly 120 can be used as an independent device to generate sound, or can be mounted at a display device to form a sound-generating display device. The sound-generating display device can display a screen while generating sound. For example, a sound-generating display device may be an electronic device or device assembly, such as a monitor or a display screen, capable of generating sound. For example, through a lamination process, the vibration diaphragm of the sound assembly 120 can be combined with a display screen. Thus, the display device can display an image and also generate and output sound through the vibration of the vibration diaphragm.

In embodiments of the present disclosure, the sound assembly 120 can change the sound direction by adjusting the deflection of the vibration diaphragm. The sound focus point 110 may be the position of the user using the display device or a designated sound focus position. By controlling the deflection and vibration of the vibration diaphragm on the sound assembly 120, the sound generated by the vibration diaphragm can be focused on the sound focus point 110. When the position of the sound focus point 110 changes, the state of the electrode structure can be adjusted to allow the vibration diaphragm to perform corresponding deflection and vibration. Therefore, the sound can be sent to a new focus position.

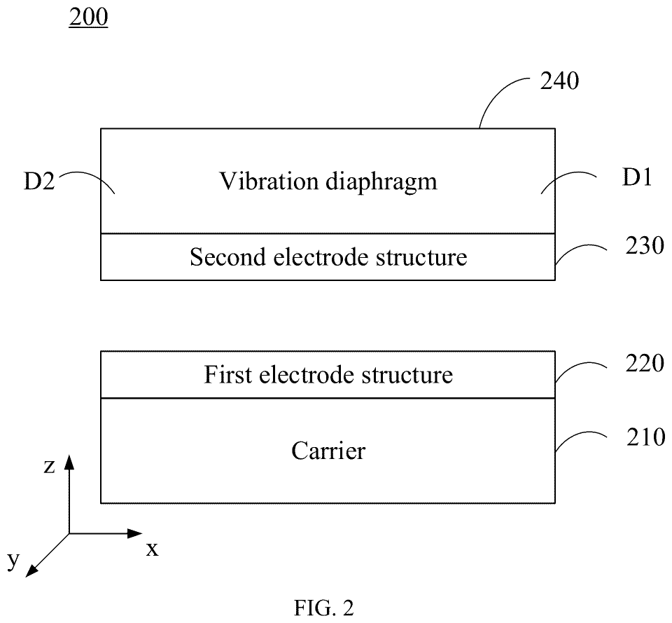

Then, the sound assembly of embodiments of the present disclosure is further described with reference to FIGS. 2 to 5.

FIG. 2 is a schematic structural diagram of a sound assembly 200 according to some embodiments of the present disclosure.

As shown in FIG. 2, the sound assembly 200 includes a carrier 210, a first electrode structure 220, a second electrode structure 230, and a vibration diaphragm 240.

In embodiments of the present disclosure, the first electrode structure 220 is arranged on one side of the carrier 210 along the first direction. The second electrode structure 230 is arranged on one side of the first electrode structure 220 along the first direction, is insulated from the first electrode structure 220, and is capable of cooperating with the first electrode structure 220 to provide a first force and a second force satisfying the perpendicular condition with the first direction. The vibration diaphragm 240 is arranged on one side of the second electrode structure 230 and acts in response to the first force and the second force to output sound.

In embodiments of the present disclosure, the vibration diaphragm 240 includes a first end D1 and a second end D2 along the first direction. The first force and the second force can act on the first end D1 and the second end D2, respectively. One or more of the magnitude and the acting direction can be the same or different for the first force and the second force.

In embodiments of the present disclosure, the first direction can be the x-axis direction shown in FIG. 2. The carrier 210 can be configured to provide support for the sound assembly. The first electrode structure 220 is arranged on the upper surface of the carrier 210. The first electrode structure 220 can include a first end and a second end arranged along the first direction (not shown in FIG. 2). The second electrode structure 230 is arranged above the first electrode structure 220 and does not directly contact the first electrode structure 220, or is in insulated contact with the first electrode structure 220. Air can exist between the first electrode structure 220 and the second electrode structure 230. The relative movement between the second electrode structure 230 and the first electrode structure 220 can cause vibration of the air to help improve the sound generation effect.

The second electrode structure 230 can include a first end and a second end arranged along the first direction. The first end of the second electrode structure 230 is arranged above the first end of the first electrode structure 220 (along the z-axis direction). The second end of the second electrode structure 230 is arranged above the second end of the first electrode structure 220.

When the first electrode structure 220 and the second electrode structure 230 are powered, an attractive force or a repulsive force can be generated between the first electrode structure 220 and the second electrode structure 230. The first electrode structure 220 and the second electrode structure 230 can be arranged along the first direction. The force applied to the first end D1 of the vibration diaphragm 240 can be the first force, and the force applied to the second end D2 can be the second force.

For example, the first end D1 can be arranged at the right end of the vibration diaphragm 240. The right side of the first electrode structure 220 can be the first end of the first electrode structure 220. The right side of the second electrode structure 230 can be the first end of the second electrode structure 230. The first force can be the force between the first end of the first electrode structure 220 and the first end of the second electrode structure 230. Under the first force, the first end D1 can move upward (along the z-axis direction) or downward (along the −z-axis direction).

For example, the second end D2 can be arranged on the left side of the vibration diaphragm 240. The left side of the first electrode structure 220 can be the second end of the first electrode structure 220. The left side of the second electrode structure 230 can be the second end of the second electrode structure 230. The second force can be the force between the second end of the first electrode structure 220 and the second end of the second electrode structure 230. Under the second force, the second end D2 can move upward (along the z-axis direction) or downward (along the −z-axis direction).

For example, a voltage can be applied to the first end of the first electrode structure 220 and the first end of the second electrode structure 230, so that a current loop can be formed between the first end of the first electrode structure 220 and the first end of the second electrode structure 230. Then, a magnetic field can be formed. Under the magnetic field, the first end of the first electrode structure 220 and the first end of the second electrode structure 230 can generate a mutually attractive force or a mutually repulsive force.

Similarly, a voltage can be applied to the second end of the first electrode structure 220 and the second end of the second electrode structure 230, so that a current loop can be formed between the second end of the first electrode structure 220 and the second end of the second electrode structure 230. Then, a magnetic field can be formed. Under the magnetic field, the second end of the first electrode structure 220 and the second end of the second electrode structure 230 can generate a mutually attractive force or a mutually repulsive force.

In embodiments of the present disclosure, the vibration diaphragm 240 can have a displacement to the left (along the x-axis direction) or to the right (along the x-axis direction) under the combined action of the first force and the second force.

For example, the forces between the first electrode structure 220 and the second electrode structure 230 can form the first force and the second force along the z-axis direction, respectively. For example, the first force acting on the first end D1 can be the attractive force between the first electrode structure 220 and the second electrode structure 230. The second force acting on the second end D2 can be the repulsive force between the first electrode structure 220 and the second electrode structure 230. Under the combined action of the first force and the second force, the vibration diaphragm 240 can deflect to the right (the second end D2 of the vibration diaphragm 240 moving in the z-axis direction, and the first end D1 of the vibration diaphragm 240 moving in the −z-axis direction).

For example, the first force and the second force can both be attractive forces, but the magnitudes of the first force and the second force can be different. If the first force acting on the first end D1 is greater than the second force acting on the second end D2, under the combined action of the first force and the second force, the vibration diaphragm 240 can deflect to the left side (the second end D2 of the vibration diaphragm 240 moving in the −z-axis direction, and the first end D1 of the vibration diaphragm 240 moving in the z-axis direction).

According to embodiments of the present disclosure, different electrical signals can be provided to the two ends of the two electrode structures in the sound assembly 200 to generate the first force and the second force acting on the first end D1 and the second end D2 of the vibration diaphragm 240. By controlling the electrical signals, the first force and the second force acting on the first end D1 and the second end D2 of the vibration diaphragm 240 can be changed. Thus, the deflection and the vibration of the vibration diaphragm 240 can be realized to change the propagation direction of the sound. For example, the sound can be focused on the position of the user to improve the user video and audio experience. In addition, by changing the voltage applied to the first electrode structure 220 and the second electrode structure 230, the second electrode structure 230 can be controlled to alternately move in the direction approaching and the direction away from the first electrode structure 220 continuously. Then, the vibration diaphragm 240 can vibrate and generate sound.

According to embodiments of the present disclosure, the first electrode structure 220 can include a conductive circuit. The conductive circuit can be printed or etched on the carrier.

In embodiments of the present disclosure, to reduce the circuit scale, the first electrode structure 220 can be etched in the form of a conductive circuit on the carrier 210.

When the first electrode structure 220 is fixed relative to the carrier 210, the force between the first electrode structure 220 and the second electrode structure 230 can cause the second electrode structure 230 to act to generate the first force and the second force to drive the vibration diaphragm 240 to deflect.

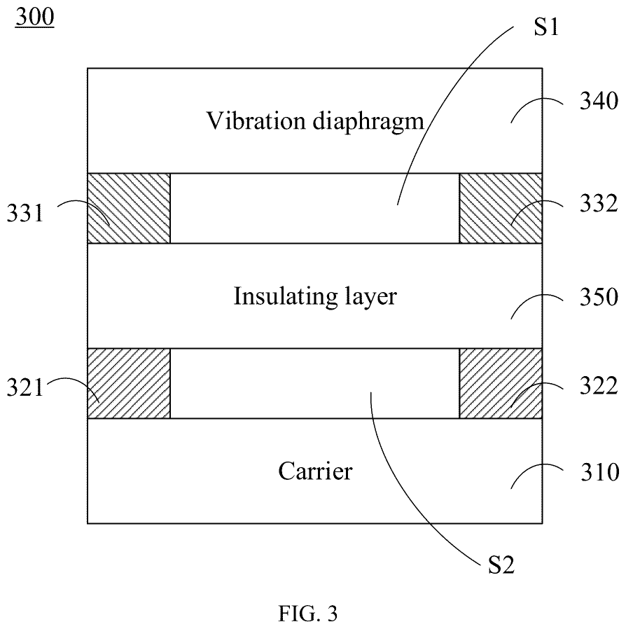

FIG. 3 is a schematic structural diagram of another sound assembly 300 according to some embodiments of the present disclosure.

As shown in FIG. 3, the sound assembly 300 includes a carrier 310, a first electrode structure, a second electrode structure, an insulating layer 350, and a vibration diaphragm 340. For the carrier 310 and the vibration diaphragm 340, references can be made to the description of the carrier 210 and the vibration diaphragm 240 above, which is not repeated here.

In embodiments of the present disclosure, the first electrode structure includes a first sub-electrode 321 and a second sub-electrode 322. The first sub-electrode 321 and the second sub-electrode 322 are oppositely arranged on two sides of the carrier 210 along the first direction. The second electrode structure includes a third sub-electrode 331 and a fourth sub-electrode 332. The third sub-electrode 331 is arranged on one side of the first sub-electrode 321, and the fourth sub-electrode 332 is arranged on one side of the second sub-electrode 322.

In embodiments of the present disclosure, the first sub-electrode 321 and the second sub-electrode 322 can be arranged on the upper surface of the carrier 210. For example, the first sub-electrode 321 in the first electrode structure can be arranged on the left side of the carrier 210, and the second sub-electrode 322 can be arranged on the right side of the carrier 210. The layout of the second electrode structure can be similar to the layout of the first electrode structure. The third sub-electrode 331 and the fourth sub-electrode 332 can be arranged on the lower surface of the vibration diaphragm 240. The third sub-electrode 331 in the second electrode structure can be arranged on the left side of the vibration diaphragm 240. The fourth sub-electrode 332 can be arranged on the right side of the vibration diaphragm 240.

For example, when the first sub-electrode 321 and the third sub-electrode 331 form a mutually attractive magnetic field under the control of the applied voltage, the second force acting on the second end D2 of the vibration diaphragm can be the force from the third sub-electrode 331 to the first sub-electrode 321. For example, when the first sub-electrode 321 and the third sub-electrode 331 form a mutually repulsive magnetic field under the control of the applied voltage, the second force acting on the second end D2 of the vibration diaphragm can be the force from the first sub-electrode 321 to the third sub-electrode 331.

In embodiments of the present disclosure, the third sub-electrode 331 can be arranged above the first sub-electrode 321, and the fourth sub-electrode 332 can be arranged above the second sub-electrode 322. By applying voltage to the third sub-electrode 331 and the first sub-electrode 321, a first voltage difference can be formed between the third sub-electrode 331 and the first sub-electrode 321. By applying voltage to the fourth sub-electrode 332 and the second sub-electrode 322, a second voltage difference can be formed between the fourth sub-electrode 332 and the second sub-electrode 322. The vibration diaphragm 340 can deflect in response to a difference between the first voltage difference and the second voltage difference.

When the difference between the first voltage difference and the second voltage difference is different, the force formed between the third sub-electrode 331 and the first sub-electrode 321 can be different from the force formed between the fourth sub-electrode 332 and the second sub-electrode 322. Thus, the first force and the second force applied to the first end and the second end of the vibration diaphragm 340 can be different to cause the vibration diaphragm 340 to deflect.

In embodiments of the present disclosure, the degree of attraction or repulsion between the first sub-electrode 321 and the third sub-electrode 331 can be controlled through the driving voltage signal, and the degree of attraction or repulsion between the fourth sub-electrode 332 and the second sub-electrode 322 can be controlled through the driving voltage signal. Thus, the vibration diaphragm 340 can deflect.

For example, the driving electrical signal can be an alternating voltage. The voltage amplitude of the driving electrical signal can change regularly or irregularly. The voltage of the driving electrical signal can change between positive voltage and negative voltage. The change frequency can be regular or irregular. Specific parameters of the driving electrical signal can be determined based on the sound information to be output.

In embodiments of the present disclosure, corresponding driving voltages can be applied to the first sub-electrode 321, the second sub-electrode 322, the third sub-electrode 331, and the fourth sub-electrode 332, respectively.

In embodiments of the present disclosure, the behavior of the vibration diaphragm 340 can be controlled by the first sub-electrode 321, the second sub-electrode 322, the third sub-electrode 331, and the fourth sub-electrode 332. For the scenario of front sound emission at a vertical angle (z-axis direction), the loop current formed by the voltage difference between the first sub-electrode 321 and the third sub-electrode 331 can be consistent with the loop current formed by the voltage difference between the second sub-electrode 322 and the fourth sub-electrode 332. Then, the displacement of the first end and the displacement of the second end of the vibration diaphragm 340 can be the same to achieve the front sound emission effect. When the sound in the designated direction deflects, by controlling the current intensity of the first sub-electrode 321, the second sub-electrode 322, the third sub-electrode 331, and the fourth sub-electrode 332, the current intensities in the two current loops can be inconsistent. Thus, the displacement of the first end and the displacement of the second end of the vibration diaphragm 340 can be inconsistent to allow the vibration diaphragm 340 to deflect.

In embodiments of the present disclosure, an insulating layer 350 can be arranged between the first electrode structure and the second electrode structure.

According to embodiments of the present disclosure, the insulating layer 350 can be arranged between the first electrode structure and the second electrode structure. A first space S1 can be formed between the insulating layer 350 and the vibration diaphragm 340. In some other embodiments, the first space S1 can be formed between the insulating layer 350 and the vibration diaphragm 340, and a second space S2 can be formed between the insulating layer 350 and the carrier 340.

In embodiments of the present disclosure, the vibration diaphragm 340 can be arranged above the second electrode structure, and the insulating layer 350 can be arranged below the second electrode structure. The space between the third sub-electrode 331 and the fourth sub-electrode 332 of the second electrode structure can be the first space S1. When the first force and the second force act on the vibration diaphragm 340, the vibration diaphragm 340 can deflect by squeezing the first space S1.

In embodiments of the present disclosure, if the first electrode structure is a conductive circuit etched on the carrier 310, the insulating layer 350 and the carrier 310 can be in a completely fitting state, and the displacement of the vibration diaphragm 340 may be achieved through deflection by squeezing the first space S1. If the first electrode structure is an electrode structure arranged on the upper surface of the carrier 310, the second space S2 may also exist between the first sub-electrode 321 and the second sub-electrode 322 of the first electrode structure.

When the vibration diaphragm 340 is displaced, by squeezing the first space S1 and the second space S2, a larger space can be provided for the deformation of the vibration diaphragm 340, and the movable area can be expanded. Thus, the audio effect can be enhanced, and the user video and audio experience can be improved. The second space S2 can provide sufficient space when the insulating layer 350 deforms to enhance the audio effect.

In embodiments of the present disclosure, a microstructure can be arranged in the insulating layer 350.

In embodiments of the present disclosure, the surface of the microstructure can include a convex surface and a concave surface. Under the action of the repulsive force and the attractive force between the first electrode structure and the second electrode structure, the insulating layer 350 can deform. With the microstructure, the deformation capacity of the insulating layer 350 can be increased, and the vibration amplitude of the insulating layer 350 can be enhanced to enhance the sound effect. In addition, through the deformation of the insulating layer 350, the displacement capacity of the vibration diaphragm 240 can also be enhanced.

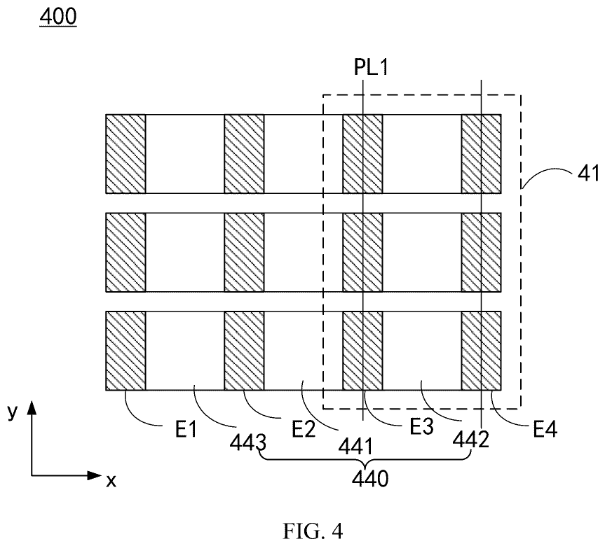

FIG. 4 is a schematic top view of another sound assembly 400 according to some embodiments of the present disclosure. As shown in FIG. 4, the sound assembly 400 includes a plurality of vibration diaphragms 440 arranged in order.

According to embodiments of the present disclosure, the vibration diaphragm 440 can include a plurality of vibration diaphragms, and the plurality of vibration diaphragms can be arranged along the first direction. Two neighboring vibration diaphragms can share an electrode structure.

In embodiments of the present disclosure, the first direction is the x-axis direction as shown in FIG. 4. The sound assembly 400 includes an electrode structure E1, an electrode structure E2, an electrode structure E3, and an electrode structure E4. The vibration diaphragm 441 and the vibration diaphragm 442 arranged along the first direction can share the electrode structure E3. The electrode structures used by the vibration diaphragm 441 can include the electrode structure E2 and the electrode structure E3. The electrode structures used by the vibration diaphragm 442 can include the electrode structure E3 and the electrode structure E4.

For example, the electrode structure E1 can be the first sub-electrode of the vibration diaphragm 443, and the electrode structure E2 can be the second sub-electrode of the vibration diaphragm 443. The electrode structure E2 can be the first sub-electrode of vibration diaphragm 441, and the electrode structure E3 can be the second sub-electrode of vibration diaphragm 441. The electrode structure E3 can be the first sub-electrode of the vibration diaphragm 442, and the electrode structure E4 can be the second sub-electrode of the vibration diaphragm 442.

In embodiments of the present disclosure, the vibration diaphragm can also include a plurality of vibration diaphragms, and the plurality of vibration diaphragms can be arranged along the second direction. The second direction can meet the perpendicular condition with the first direction. The plurality of first electrode structures corresponding to the plurality of vibration diaphragms arranged in the second direction can be powered by the first power supply circuit. The plurality of second electrode structures can be powered by the second power supply circuit.

In embodiments of the present disclosure, the second direction can be the y-axis direction, as shown in FIG. 4, which is perpendicular to the x-axis direction. The electrode structures used by the plurality of vibration diaphragms arranged along the second direction can be powered by the same power supply circuit. The circuit of supplying power to the first electrode structure corresponding to the vibration diaphragm can be a first power supply circuit PL1, and the circuit of supplying power to the second electrode structure corresponding to the vibration diaphragm can be the second power supply circuit.

For example, as shown in FIG. 4, the first electrode structures corresponding to the plurality of vibration diaphragms arranged along the second direction are powered by the first power supply circuit PL1. Voltage can be provided to the first electrode structures via the first power supply circuit PL1.

The second electrode structures corresponding to the plurality of vibration

diaphragms arranged along the second direction can be powered by the second power supply circuit. Voltage can be provided to the second electrode structures via the second power supply circuit.

In embodiments of the present disclosure, since the first electrode structures and the second electrode structures of the plurality of vibration diaphragms arranged along the second direction are powered through the same power supply circuit, the plurality of vibration diaphragms arranged along the second direction can be regarded as a diaphragm channel 41. The plurality of vibration diaphragms in the diaphragm channel 41 can have the same deflection amplitude.

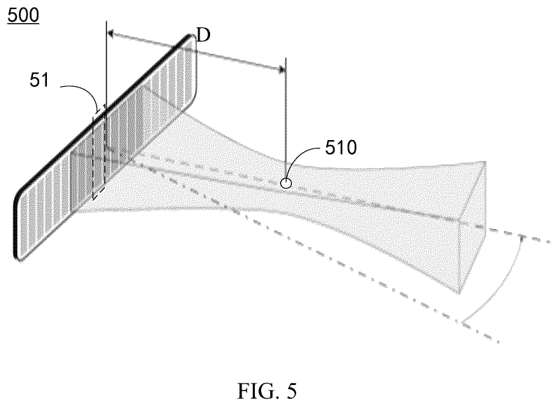

FIG. 5 schematically illustrates a schematic diagram of the sound assembly according to an embodiment of the present disclosure.

As shown in FIG. 5, in the application scenario 500, the sound assembly includes a plurality of diaphragm channels 51. Sounds generated by the plurality of diaphragm channels 51 can converge at the sound focus point 510. Since the deflection amplitudes of the vibration diaphragms in the different diaphragm channels are different, the sounds generated by the vibration diaphragms through the vibration can propagate in the direction to the sound focus point 510 outside the displacement distance D. The user can be at the position of the sound focus point 510 and can have a good audio experience. When the position at the sound focus point 510 changes, the displacement amplitude of the plurality of diaphragm channels 51 in the sound assembly can change to have a displacement in the direction toward the new sound focus point.

In embodiments of the present disclosure, a plurality of diaphragm channels can be driven independently through hardware, so that the vibration diaphragms can deflect and vibrate to accurately achieve sound deflection and orientation and improve the user sound effect experience.

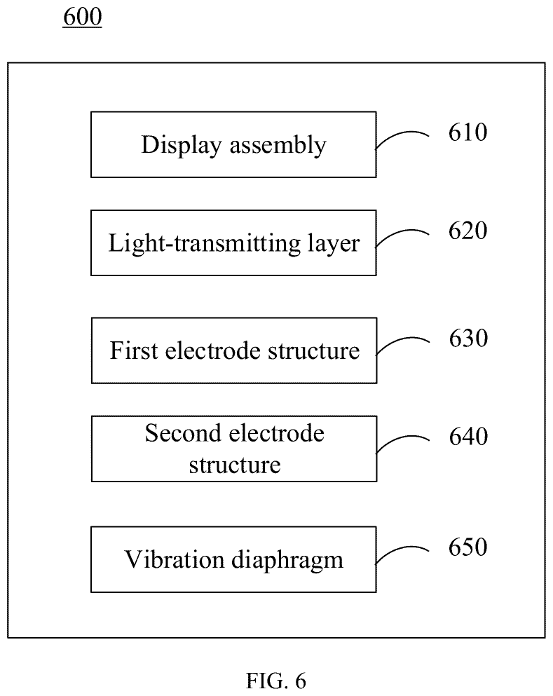

FIG. 6 is a schematic block diagram of an electronic device 600 according to some embodiments of the present disclosure.

As shown in FIG. 6, the electronic device 600 includes a display assembly 610, a light-transmitting layer 620, a first electrode structure 630, a second electrode structure 640, and a vibration diaphragm 650.

The display assembly 610 can output an image. The image can be in a visible

state via the first side and the second side of the light-transmitting layer 620. In embodiments of the present disclosure, the light-transmitting layer 620, the first electrode structure 630, the second electrode structure 640, and the vibration diaphragm 650 can be similar to the carrier 210, the first electrode structure 220, the second electrode structure 230, and the vibration diaphragm 240 in the sound assembly 200 described above, which are not repeated here. The first side and the second side can be a lower side and an upper side of the light-transmitting layer 620.

In embodiments of the present disclosure, the vibration diaphragm 650 can be laminated to the display assembly 610 by a CG+OCA (Optically Clear Adhesive) lamination process and a CG+LCM (Liquid Crystal Display Module) lamination process. Then, after processes, such as degassing and curing, and procedures, such as blanking inspection, function inspection, and appearance inspection, the electronic device 600 can be obtained by combining the vibration diaphragm 650 and the display assembly 610.

The first electrode structure 630 can be arranged on the second side of the light-transmitting layer 620 along the first direction. The second electrode structure 640 can be arranged on one side of the first electrode structure 630 along the first direction and is insulated from the first electrode structure 630. The second electrode structure 640 can cooperate with the first electrode structure 630 to provide a first force and a second force that meet the perpendicular condition with respect to the first direction. The vibration diaphragm 650 can be arranged on one side of the second electrode structure 640 and can operate in response to the first force and/or the second force. The vibration diaphragm 650 can include a first end and a second end along the first direction. The first force and the second force can act on the first end and the second end, respectively. The magnitudes and/or acting directions of the first force and the second force can be different.

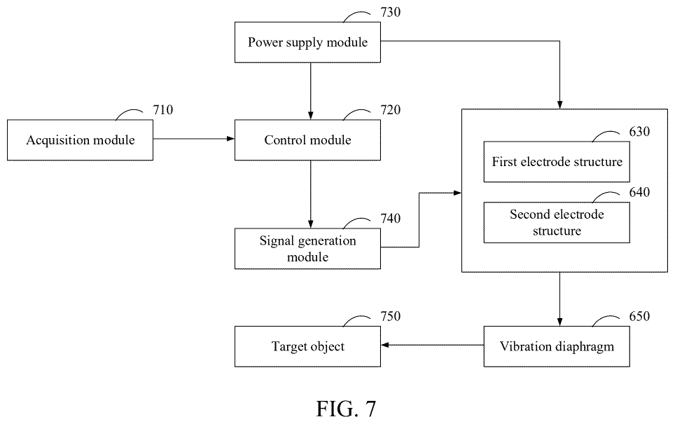

FIG. 7 is a schematic block diagram of another electronic device according to some embodiments of the present disclosure.

As shown in FIG. 7, the electronic device further includes an acquisition module 710, a control module 720, a power supply module 730, a signal generation module 740, and a target object 750.

The acquisition module 710 can be configured to determine the position

information of the target object 750. The control module 720 can be configured to control the operation states of the first electrode structure 630 and the second electrode structure 640 according to the position information of the target object 750, so that the sound range output by the operation of the vibration diaphragm 650 can have a corresponding relationship with the target object 750. The power supply module 730 can be configured to supply power to the control module 720, the first electrode structure 630, and the second electrode structure 640. The signal generation module 740 can be configured to generate control signals under the control of the control module and send the control signals to the first electrode structure 630 and the second electrode structure 640, respectively. The first electrode structure 630 and the second electrode structure 640 can generate a first force and a second force acting on the vibration diaphragm 650 under the influence of the control signals. Thus, the vibration diaphragm 650 can deflect to send sound to the target object 750 and focus the sound at the position of the target object 750.

For example, the acquisition module 710 can be a TOF (Time of Flight) sensor, which emits ultrasound or infrared signals and receives the returned signals. The acquisition module 710 can also be configured to calculate the direction and distance of the target object 750 according to information such as the time between the emission and reception to determine the position information of the target object 750.

For example, the control module 720 can be a Microcontroller Unit (MCU), which receives the position information sent by the acquisition module 710 through a serial port, determines the deflection angle of the vibration diaphragm of each sound-generation channel based on the position information, and controls the signal generation module 740 based on the deflection angle to generate the control signals for controlling the first electrode structure 630 and the second electrode structure 640 to allow the vibration diaphragm of each sound-generation channel to deflect this angle.

In embodiments of the present disclosure, the user can be positioned using the TOF sensor and the obtained position information can be output to the digital signal processing unit to generate the control signal in real-time to control the vibration diaphragms of the diaphragm channels to move to change the sound direction. Thus, the user can have a good sound experience when viewing the display device.

In embodiments of the present disclosure, at least some functions of any number of modules, sub-modules, units, and sub-units, or any number thereof can be implemented in a module. In embodiments of the present disclosure, one or more of the modules, sub-modules, units, and sub-units can be divided into a plurality of modules for implementation. In embodiments of the present disclosure, one or more of the modules, sub-modules, units, and sub-units can be at least partially implemented as a hardware circuit, e.g., Field Programmable Gate Arrays (FPGA), Programmable Logic Arrays (PLA), System-on-Chip (SoC), System-in-Package (SiP), System-on-Board, Application-Specific Integrated Circuits (ASIC), or hardware or firmware implemented in any other reasonable manner by integrating or packaging circuits, or implemented in any one of software, hardware, and firmware, or an appropriate combination thereof. In some other embodiments, one or more of the modules, sub-modules, units, and sub-units in embodiments of the present disclosure can be implemented at least partially as computer program modules that, when executed, can perform the corresponding functions.

The present disclosure also provides a computer-readable medium. The computer-readable medium can be included in the devices/apparatuses/systems described above or can exist independently, without being mounted into the devices/apparatuses/systems. The above-mentioned computer-readable medium can include one or more programs that, when executed, implement the method of embodiments of the present disclosure.

In embodiments of the present disclosure, the computer-readable medium can be a computer-readable signal medium, a computer-readable storage medium, or any combination thereof. A computer-readable storage medium can be, but is not limited to, electrical, magnetic, optical, electromagnetic, infrared, or semiconductor systems, devices, or apparatuses, or any combination thereof. More specific examples of computer-readable storage media may include, but are not limited to, electrical connections having one or more wires, portable computer disks, hard disks, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination thereof. In the present disclosure, the computer-readable storage medium can be any tangible medium that contains or stores a program. The program can be used or combined with an instruction execution system, device, or apparatus. In the present disclosure, the computer-readable signal medium can include a data signal propagated in a baseband or as a part of a carrier, which carries computer-readable program codes. Such a propagated data signal can have various forms, including but not limited to electromagnetic signals, optical signals, or any suitable combination thereof. The computer-readable signal medium can also include any computer-readable medium other than a computer-readable storage medium. The computer-readable medium can transmit, propagate, or transport a program for use by or in connection with an instruction execution system, device, or apparatus. The program codes included in a computer-readable medium can be transmitted using any suitable medium, including but not limited to, wireless means, wired means, optical cables, radio frequency signals, or any suitable combination thereof.

The flowcharts and block diagrams in the accompanying drawings illustrate possible implemented system architectures, functions, and operations of the system, method, and computer program product of embodiments of the present disclosure. Each block in the flowcharts or block diagrams may represent a module, program segment, or portion of code. The module, program segment, or portion of code can include one or more executable instructions for implementing the specified logical function. In some alternative implementations, the functions marked in the blocks can also occur in an order different from the order indicated in the drawings. For example, two connected blocks may in fact be executed substantially concurrently, and sometimes may also be executed in a reverse order, which depends on the functionality involved. Each block in the block diagrams or flowcharts, as well as combinations of blocks in the block diagrams or flowcharts, can be implemented by a special-purpose hardware-based system that performs the specified functions or operations, or can be implemented by a combination of special-purpose hardware and computer instructions.

Those skilled in the art can understand that the features described in various embodiments of the present disclosure and/or claims can be combined and/or associated in various methods, even if such combinations or associations are not explicitly described in the present disclosure. In particular, without departing from the spirit and teachings of the present disclosure, the features described in various embodiments of the present disclosure and/or claims can be combined and/or associated in multiple methods. All such combinations and/or associations fall within the scope of the present disclosure.

Although the present disclosure has been shown and described with reference to specific exemplary embodiments of the present disclosure, those skilled in the art should understand that various modifications in form and detail can be made to the present disclosure without departing from the spirit and scope of the present disclosure as defined by the appended claims and their equivalents. Therefore, the scope of the present disclosure should not be limited to the above embodiments but should be determined not only by the appended claims but also by the equivalents of the appended claims.

What is claimed is:

1. A sound assembly comprising:
a carrier;
a first electrode structure arranged on one side of the carrier;
a second electrode structure arranged facing and insulated from the first electrode structure; and
a vibration diaphragm arranged on one side of the second electrode structure that faces away from the first electrode structure;
wherein:
the first electrode structure and the second electrode structure are configured to cooperate with each other to provide a first force that acts on a first end of the vibration diaphragm and a second force that acts on a second end of the vibration diaphragm; and
magnitudes and/or acting directions of the first force and the second force are different.

2. The sound assembly according to claim 1, further comprising:
an insulating layer formed between the first electrode structure and the second electrode structure, a space being formed between the insulating layer and the vibration diaphragm.

3. The sound assembly according to claim 2, wherein:
the space is a first space; and
a second space is formed between the insulating layer and the carrier.

4. The sound assembly according to claim 2, wherein the insulating layer includes a microstructure.

5. The sound assembly according to claim 1, wherein:
the first electrode structure includes a first sub-electrode and a second sub-electrode that are arranged on two end parts of the carrier, respectively; and
the second electrode structure includes a third sub-electrode and a fourth sub-electrode, the third sub-electrode is provided at a part of the second electrode structure that is closer to the first sub-electrode than to the second sub-electrode, and the fourth sub-electrode is provided at another part of the second electrode structure that is closer to the second sub-electrode than to the first sub-electrode.

6. The sound assembly according to claim 1, wherein the vibration diaphragm is one of two vibration diaphragms sharing at least one of the first electrode structure or the second electrode structure.

7. The sound assembly according to claim 1, wherein:
the first end and the second end are arranged along a first direction;
the vibration diaphragm is one of a plurality of vibration diaphragms arranged along a second direction satisfying a perpendicular condition with the first direction;
the first electrode structure is one of a plurality of first electrode structures arranged along the second direction and each corresponding to one of the plurality of vibration diaphragms, the plurality of first electrode structures being powered by a first power supply circuit; and
the second electrode structure is one of a plurality of second electrode structures arranged along the second direction and each corresponding to one of the plurality of vibration diaphragms, the plurality of second electrode structures being powered by a second power supply circuit.

8. The sound-producing module according to claim 1, wherein the first electrode structure includes a conductive circuit printed or etched on the carrier.

9. An electronic device comprising:
a display assembly configured to output an image;
a light-transmitting layer configured to allow the image to be visible through the light-transmitting layer, the light-transmitting layer having a first side facing the display assembly and a second side facing away from the display assembly;
a first electrode structure arranged on the second side of the light-transmitting layer;
a second electrode structure arranged facing and insulated from the first electrode structure; and
a vibration diaphragm arranged on one side of the second electrode structure that faces away from the first electrode structure;
wherein:
the first electrode structure and the second electrode structure are configured to cooperate with each other to provide a first force that acts on a first end of the vibration diaphragm and a second force that acts on a second end of the vibration diaphragm; and
magnitudes and/or acting directions of the first force and the second force are different.

10. The electronic device according to claim 9, further comprising:
an acquisition module configured to determine position information of a target object; and
a control module configured to, according to the position information of the target object, control operating states of the first electrode structure and the second electrode structure, so that a sound range output by an operation of the vibration diaphragm corresponds to the target object.

11. The electronic device according to claim 9, further comprising:
a signal generation module configured to generate control signals under control of the control module and send the control signals to the first electrode structure and the second electrode structure, respectively.

12. The electronic device according to claim 9, further comprising:
an insulating layer formed between the first electrode structure and the second electrode structure, a space being formed between the insulating layer and the vibration diaphragm.

13. The electronic device according to claim 12, wherein:
the first space is a first space; and
a second space is formed between the insulating layer and the light-transmitting layer.

14. The electronic device according to claim 12, wherein the insulating layer includes a microstructure.

15. The electronic device according to claim 9, wherein:
the first electrode structure includes a first sub-electrode and a second sub-electrode that are arranged on two end parts of the light-transmitting layer, respectively; and
the second electrode structure includes a third sub-electrode and a fourth sub-electrode, the third sub-electrode is provided at a part of the second electrode structure that is closer to the first sub-electrode than to the second sub-electrode, and the fourth sub-electrode is provided at another part of the second electrode structure that is closer to the second sub-electrode than to the first sub-electrode.

16. The electronic device according to claim 9, wherein the vibration diaphragm is one of two vibration diaphragms sharing at least one of the first electrode structure or the second electrode structure.

17. The electronic device according to claim 9, wherein:
the first end and the second end are arranged along a first direction;
the vibration diaphragm is one of a plurality of vibration diaphragms arranged along a second direction satisfying a perpendicular condition with the first direction;
the first electrode structure is one of a plurality of first electrode structures arranged along the second direction and each corresponding to one of the plurality of vibration diaphragms, the plurality of first electrode structures being powered by a first power supply circuit; and
the second electrode structure is one of a plurality of second electrode structures arranged along the second direction and each corresponding to one of the plurality of vibration diaphragms, the plurality of second electrode structures being powered by a second power supply circuit.

18. The electronic device according to claim 9, wherein the first electrode structure includes a conductive circuit printed or etched on the light-transmitting layer.
